(19) United States
(12) Patent Application Publication
(10) Pub. No.: US 2010/0225890 A1
(43) Pub. Date: Sep. 9, 2010

(54) METHOD FOR EVALUATING FLARE IN EXPOSURE TOOL

(76) Inventors: Satoshi NAGAI, Kawasaki-Shi (JP); Kazuya FUKUHARA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/564,879

(22) Filed: Sep. 22, 2009

(30) Foreign Application Priority Data
Mar. 3, 2009 (JP) 2009-49126

(51) Int. Cl. G01J 1/10; G03B 27/54

(52) U.S. Cl. 355/67; 356/229

(57) ABSTRACT

A method for evaluating flare of an exposure tool has measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film; calculating a first evaluation value by dividing the unit reference integral exposure amount by the first reference integral exposure amount; and evaluating a total flare amount of the illuminating optical system and the projecting optical system, using the first evaluation value.

### CROSS-REFERENCE TO RELATED APPLICATION

This application is based upon and claims the benefit of priority from the prior Japanese Patent Application No. 2009-49126, filed on Mar. 3, 2009, the entire contents of which are incorporated herein by reference.

### BACKGROUND OF THE INVENTION

1. Field of the Invention

The present invention relates to a method for evaluating flare in an exposure tool that is used in a photolithography process.

2. Background Art

In recent years, there is a demand for even smaller semiconductor devices.

In a photolithography process, a pattern formed on a mask (a reticle) is projected through exposure onto a semiconductor substrate (a wafer) having a photosensitive agent such as a photoresist applied thereto.

Among exposure tools that perform such projection and exposure, there is an exposure tool that projects through exposure a pattern formed on a reticle onto a predetermined region of a wafer, and moves one step (a predetermined distance) on the wafer. The exposure tool again projects through exposure the pattern on the reticle onto the next region of the wafer (the so-called “step-and-repeat method”).

Conventional size reductions of semiconductor devices have been realized by the technical innovation in lithography processes for transferring device patterns. In reducing the sizes of semiconductor devices in future, the technique for controlling exposure tools in lithography processes is required.

When exposure is performed with such an exposure tool, it is essential that the exposure margin represented by the two factors, the exposure latitude and the focus depth, are secured.

Such an exposure tool needs to be properly controlled, so as not to reduce the exposure margin. One of the main factors that reduce the exposure margin is flare. Therefore, flare control in exposure tools is becoming more and more important.

Flare is caused by cloudiness of the optical system in an exposure tool. The optical system is mainly formed with an illuminating optical system and a projecting optical system. The main causes of cloudiness include the outgassing caused by subjecting a pericle or resist to exposure light, and the sublimate generated from foreign matters introduced when the reticle is inserted or removed. If the amount of flare caused by the cloudiness is large, the transferred pattern fidelity becomes lower, and the exposure margin becomes smaller.

There have been a number of techniques suggested to restrict flare, and a number of methods suggested to measure the flare of an illuminating optical system and the flare of a projecting optical system so as to control the flare.

In recent year, however, there is another problem that the pattern located outside the effective exposure region is also transferred onto the transferred pattern of an adjacent shot due to flare.

The amount of flare leaking out of the effective exposure region cannot be measured directly by a conventional method for measuring the flare of an illuminating optical system and the flare of a projecting optical system separately from each other. Therefore, it is difficult to set clear control criteria for the problem caused by flare.

To control the flare leaking out of the effective exposure region, it is necessary to use a technique for restricting or measuring the amount of light that leaks out of the effective exposure region and reaches the substrate to be exposed (this amount of light being hereinafter referred to as the “out-of-shot flare”).

Conventional techniques include a technique for restricting the flare from leaking out of the effective exposure region by providing a light shielding mechanism for shielding the illumination light emitted to the outside of the effective exposure region of a reticle (see Japanese Patent Laid-Open No. 11-121330, for example).

However, even when the flare leaking out of the effective exposure region is restricted, the amount of flare that is actually generated is not measured by the above technique.

### SUMMARY OF THE INVENTION

According to one aspect of the present invention, there is provided: a method for evaluating flare of an exposure tool comprising:

using a first evaluation mask that has a first effective exposure region and a first evaluation pattern formed thereon, the first effective exposure region transmitting a first transmission amount of illumination light emitted from an illuminating optical system to a projecting optical system, the first evaluation pattern being adjacent to an outside of the first effective exposure region;

projecting light transmitted from the first evaluation mask, via the projecting optical system, onto a substrate having a photosensitive film formed on an upper face thereof, by emitting illumination light from a light source onto the first evaluation mask via the illuminating optical system;

measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film;

calculating a first evaluation value by dividing the unit reference integral exposure amount by the first reference integral exposure amount; and

evaluating a total flare amount of the illuminating optical system and the projecting optical system, using the first evaluation value.

According to another aspect of the present invention, there is provided: a method for evaluating flare of an exposure tool comprising:

using a first evaluation mask that has a first effective exposure region, a first evaluation pattern formed thereon, a second effective exposure region, and a second evaluation pattern formed thereon, the first effective exposure region transmitting a first transmission amount of illumination light emitted from an illuminating optical system to a projecting optical system, the first evaluation pattern being adjacent to an outside of the first effective exposure region, the second effective exposure region transmitting a second transmission amount of illumination light to the projecting optical system, the second evaluation pattern being adjacent to an outside of the second effective exposure region, the second transmission amount being smaller than the first transmission amount;

projecting light transmitted from the first evaluation mask, via the projecting optical system, onto a substrate having a photosensitive film formed on an upper face thereof, by emitting illumination light from a light source onto the first evaluation mask via the illuminating optical system;

measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film;

measuring a second reference integral exposure amount of illumination light emitted from the light source, the second reference integral exposure amount being required for the second evaluation pattern to be developed on the photosensitive film;

calculating a first evaluation value by dividing the unit reference integral exposure amount by the first reference integral exposure amount;

calculating a second evaluation value by dividing the unit reference integral exposure amount by the second reference integral exposure amount;

evaluating a total flare amount of the illuminating optical system and the projecting optical system, using the first evaluation value; and

evaluating a flare amount of the illuminating optical system, using the second evaluation value.

According to still another aspect of the present invention, there is provided: a method for evaluating flare of an exposure tool comprising:

using a first evaluation mask and a second evaluation mask, the first evaluation mask having a first effective exposure region and a first evaluation pattern formed thereon, the first effective exposure region transmitting a first transmission amount of illumination light emitted from an illuminating optical system to a projecting optical system, the first evaluation pattern being adjacent to an outside of the first effective exposure region, the second evaluation mask having a second effective exposure region and a second evaluation pattern formed thereon, the second effective exposure region transmitting a second transmission amount of illumination light to the projecting optical system, the second evaluation pattern being adjacent to an outside of the second effective exposure region, the second transmission amount being smaller than the first transmission amount;

projecting light transmitted from the first evaluation mask, via the projecting optical system, onto a substrate having a photosensitive film formed on an upper face thereof, by emitting illumination light from a light source onto the first evaluation mask via the illuminating optical system;

projecting light transmitted from the second evaluation mask, via the projecting optical system, onto the substrate having the photosensitive film formed on the upper face thereof, by emitting illumination light from the light source onto the second evaluation mask via the illuminating optical system;

measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film;

measuring a second reference integral exposure amount of illumination light emitted from the light source, the second reference integral exposure amount being required for the second evaluation pattern to be developed on the photosensitive film;

calculating a first evaluation value by dividing the unit reference integral exposure amount by the first reference integral exposure amount;

calculating a second evaluation value by dividing the unit reference integral exposure amount by the second reference integral exposure amount;

evaluating a total flare amount of the illuminating optical system and the projecting optical system, using the first evaluation value; and

evaluating a flare amount of the illuminating optical system, using the second evaluation value.

### BRIEF DESCRIPTION OF THE DRAWINGS

FIG. 1 is a schematic view illustrating the fundamental structure of an exposure tool 1000 according to a first embodiment of the present invention;

FIG. 2 is a plane view showing an example structure of the evaluation mask 100 used for evaluating the flare in the exposure tool 1000 illustrated in FIG. 1;

FIG. 3A is a plane view showing another example structure of the evaluation mask used for evaluating the flare in the exposure tool 1000 illustrated in FIG. 1;

FIG. 3B is a plane view showing another example structure of the evaluation mask used for evaluating the flare in the exposure tool 1000 illustrated in FIG. 1;

FIG. 4A is a schematic view of an example of the position for measuring a residual amount of photosensitive film on the wafer 6 having the pattern of the evaluation mask 100 transferred on its photosensitive film;

FIG. 4B is a diagram showing the relationship between the residual amount of the photosensitive film and the integral exposure amount measured in the first evaluation region X1 and the second evaluation region X2 shown in FIG. 4A;

FIG. 5 is a flowchart showing an example of a method for evaluating the flare in the exposure tool according to the first embodiment of the present invention;

FIG. 6 is a flowchart showing another example of the method for evaluating the flare in the exposure tool according to the first embodiment of the present invention;

FIG. 7A shows the relationship between the resist film thickness in the first evaluation region X1 having the first evaluation pattern 103a of the evaluation mask 100 projected thereto, and the integral exposure amount of illumination light emitted from the light source 1;

FIG. 7B shows the relationship between the resist film thickness in the second evaluation region X2 having the second evaluation pattern 103b of the evaluation mask 100 projected thereto, and the integral exposure amount of illumination light emitted from the light source 1; and

FIG. 8 is a schematic view showing the fundamental structure of an exposure tool 2000 according to the second embodiment of the present invention.

### DETAILED DESCRIPTION

The following is a description of embodiments of the present invention, with reference to the accompanying drawings.

### First Embodiment

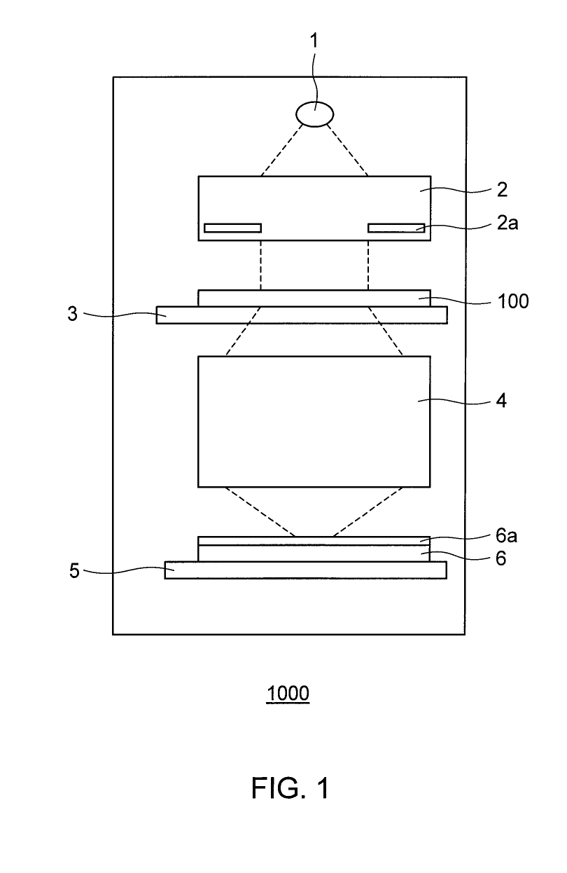

FIG. 1 is a schematic view illustrating the fundamental structure of an exposure tool 1000 according to a first embodiment of the present invention.

As shown in FIG. 1, the exposure tool 1000 includes a light source 1, an illuminating optical system 2, a mask (reticle) 100, a mask stage 3, a projecting optical system 4, and a substrate stage 5.

The light from the light source 1 is gathered by the illuminating optical system 2 formed with an ellipsoidal reflector and a collimator lens, for example, and is emitted as illumination light onto the evaluation mask 100. The illumination light is adjusted by slits 2a formed in the illuminating optical system 2, so as to be emitted onto a predetermined region (an effective exposure region) on the evaluation mask 100. Evaluation patterns are formed on the evaluation mask 100, as will be described later. The effective exposure region has a size not smaller than the region to be exposed by one short in the use of the exposure tool 1000 exposing a circuit pattern. In practice, the effective exposure region may be the largest possible size that can be exposed by one shot in principle.

The deflected light that is generated by emitting the illumination light onto the evaluation mask 100 (or the light transmitted through the evaluation mask 100) is projected onto and exposes a photosensitive film 6a applied onto a wafer (substrate) 6 placed on the substrate stage 5 via the projecting optical system 4.

An exposing operation is performed by the exposure tool 1000 repeating the shot-based exposure of the wafer 6 several times by a step-and-repeat method or a step-and-scan method, and the largest possible number of circuit patterns is formed on the wafer 6.

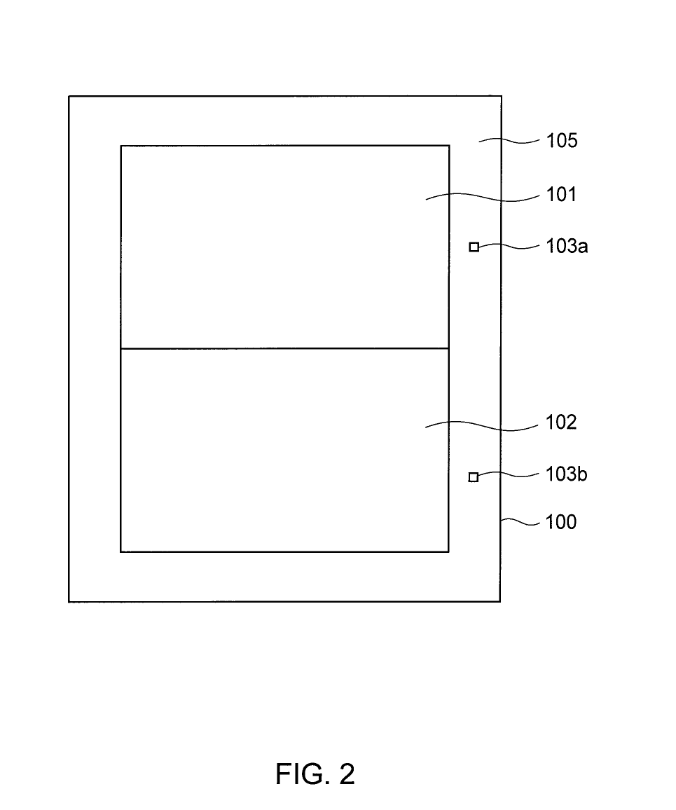

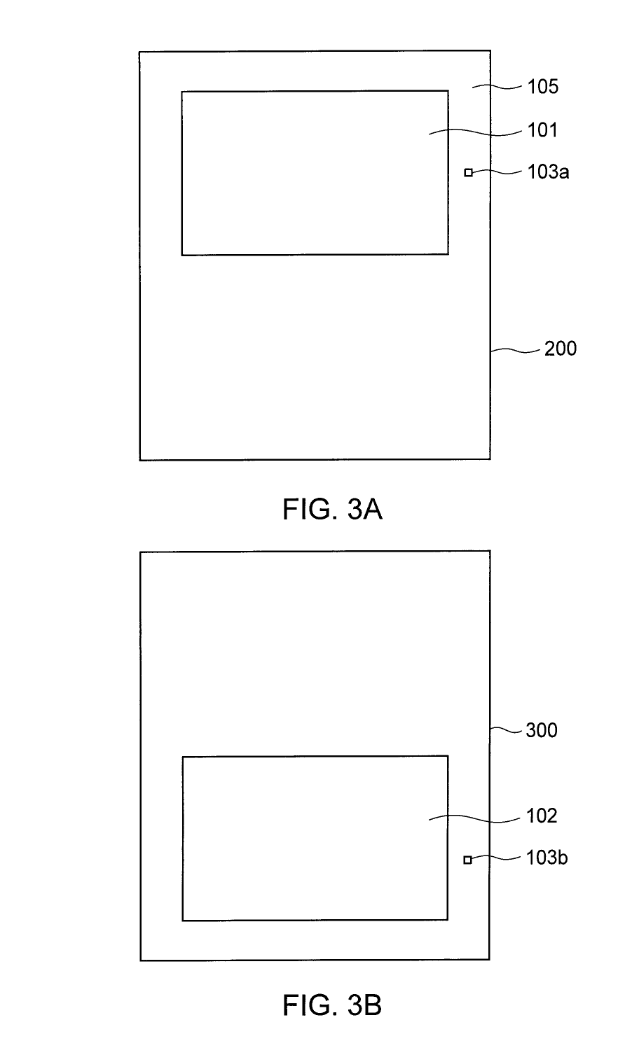

FIG. 2 is a plane view showing an example structure of the evaluation mask 100 used for evaluating the flare in the exposure tool 1000 illustrated in FIG. 1. FIGS. 3A and 3B are plane views showing another example structure of the evaluation mask used for evaluating the flare in the exposure tool 1000 illustrated in FIG. 1.

As shown in FIG. 2, the effective exposure region onto which the illumination light is emitted to develop a predetermined pattern on the photosensitive film includes a first effective exposure region 101 and a second effective exposure region 102 neighboring the first effective exposure region 101.

The first effective exposure region 101 is formed on the evaluation mask 100, and transmits the illumination light emitted from the illuminating optical system 2 to the projecting optical system 4 by a first transmission amount (the illumination light being allowed to penetrate the evaluation mask 100 in this example).

The second effective exposure region 102 transmits the illumination light to the projecting optical system 4 by a second transmission amount that is smaller than the first transmission amount.

The transmissivity of the first effective exposure region 101 having the first transmission amount is set higher than the transmissivity of the second effective exposure region 102 having the second transmission amount. For example, any pattern is not formed on the second effective exposure region 102, and the transmissivity of the second effective exposure region 102 may be set at approximately 0%. In this manner, two levels are set for the transmissivity at which the illumination light is emitted onto the projecting optical system.

On the evaluation mask 100, a peripheral region 105 is formed outside the first and second effective exposure regions 101 and 102. The transmissivity of the peripheral region 105 is set lower than that of the first effective exposure region 101.

A first evaluation pattern 103a is formed in a region of the peripheral region 105 that is near the first effective exposure region 101. The first evaluation pattern 103a transmits the illumination light to the projecting optical system (or allows the illumination light to penetrate the first evaluation pattern 103a toward the projecting optical system 4).

A second evaluation pattern 103b is formed in a region of the peripheral region 105 that is near the second effective exposure region 102. The second evaluation pattern 103b transmits the illumination light to the projecting optical system 4 (or allows the illumination light to penetrate the second evaluation pattern 103b toward the projecting optical system 4).

More specifically, in the peripheral region 105 on the evaluation mask 100, the first and second evaluation patterns 103a and 103b are formed on the inner side of a pattern formed outside a regular effective exposure region such as a reticle alignment pattern. The first and second evaluation patterns 103a and 103b have the same transmissivity as that of the first effective exposure region 101.

Accordingly, the first and second evaluation patterns 103a and 103b serve to transmit the illumination light leaking out of the effective exposure region to the projecting optical system 4.

If the illuminating optical system 2 is not clouded, the first and second evaluation patterns 103a and 103b are ideally formed in regions not to be subjected to the illumination light emitted from the illuminating optical system 2.

Here, the first and second effective exposure regions 101 and 102, and the first and second evaluation patterns 103a and 103b are formed on the single evaluation mask 100. However, as shown in FIGS. 3A and 3B, the set of the first effective exposure region 101 and the first evaluation pattern 103a may be formed on an evaluation mask 200, and the set of the second effective exposure region 102 and the second evaluation pattern 103b may be formed on an evaluation mask 300.

Next, a method for evaluating flare with the use of the flare evaluation mask 100 having the above structure is described. It should be noted that the same method may be implemented where the flare evaluation masks 200, 300 are used. Although the photosensitive film is a positive resist film in the following example, the same calculation is performed to calculate the light exposure where the photosensitive film is a negative resist film.

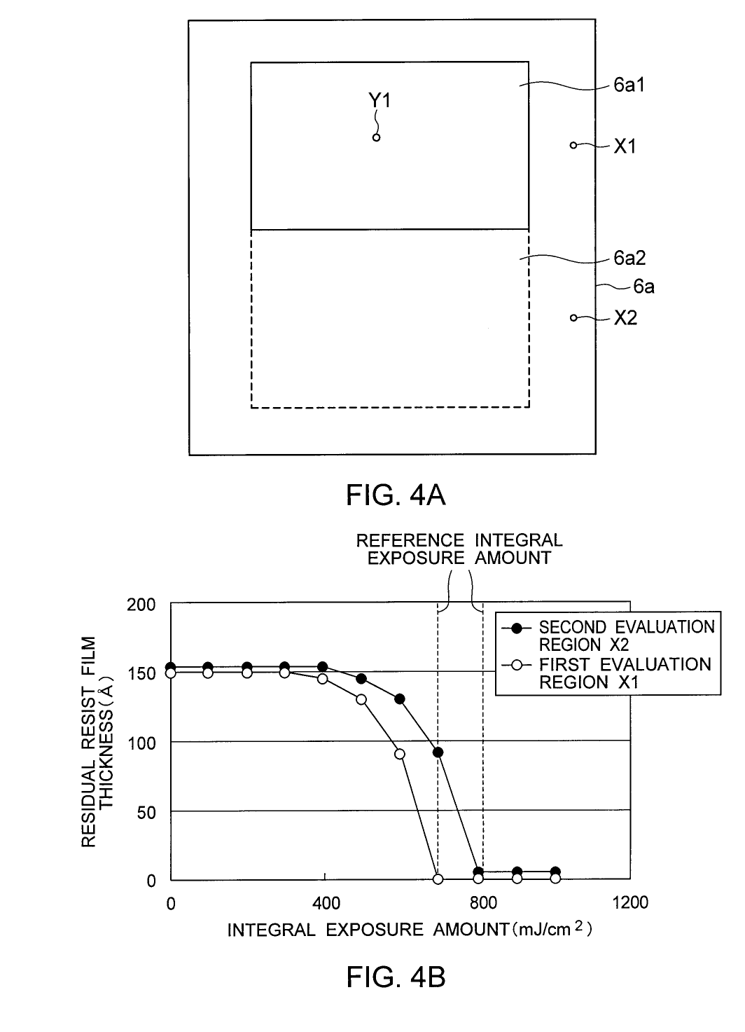

FIG. 4A is a schematic view of an example of the position for measuring a residual amount of photosensitive film on the wafer 6 having the pattern of the evaluation mask 100 transferred on its photosensitive film.

As shown in FIG. 4A, in the upper face region of the wafer 6, the portion onto which the first effective exposure region 101 of the evaluation mask 100 is projected is a first reference region 6a1. Also, in the upper face region of the wafer 6, the portion onto which the second effective exposure region 102 of the evaluation mask 100 is projected is a second reference region 6a2. In the upper face region of the wafer 6, the portion onto which the first evaluation pattern 103a adjacent to the first effective exposure region 101 is projected is a first evaluation region X1. In the upper face region of the wafer 6, the portion onto which the second evaluation pattern 103b adjacent to the second effective exposure region 102 is projected is a second evaluation region X2. If the two evaluation masks 200 and 300 shown in FIGS. 3A and 3B are used, the patterns are projected onto the wafer 6 in the same manner as illustrated in FIG. 4A.

FIG. 4B is a diagram showing the relationship between the residual amount of the photosensitive film and the integral exposure amount measured in the first evaluation region X1 and the second evaluation region X2 shown in FIG. 4A. Here, the film thickness of the resist film in each of the first evaluation region X1 onto which the first evaluation pattern 103a is projected, and the second evaluation region X2 onto which the second evaluation pattern 103b is projected. The integral exposure amount is the time integration value of the exposure amount per unit area of the illumination light (the same applies to the following examples). As shown in FIG. 4B, the integral exposure amount observed when the film thickness of the resist film is zero (or at the time of development) is the reference integral exposure amount.

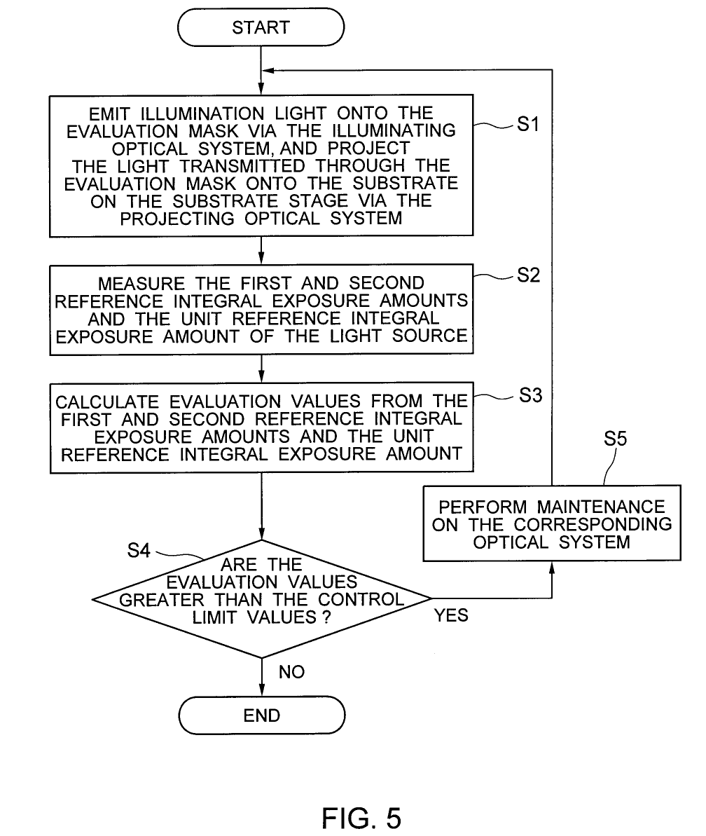

FIG. 5 is a flowchart showing an example of a method for evaluating the flare in the exposure tool according to the first embodiment of the present invention.

As shown in FIG. 5, with the use of the exposure tool 1000 in which the evaluation mask 100 shown in FIG. 2 is provided, the illumination light is emitted from the light source 1 onto the evaluation mask 100 placed on the mask stage 3 via the illuminating optical system 2. In doing so, the light transmitted through the evaluation mask 100 is projected, via the projecting optical system 4, onto the substrate stage 5 on which the wafer 6 having the photosensitive film 6a formed on its upper face is placed (step S1).

When the evaluation masks 200 and 300 shown in FIGS. 3A and 3B are used, at step S1, the illumination light is emitted from the light source 1 onto the evaluation mask 200 placed on the mask stage 3 via the illuminating optical system 2, and, independently of that, the illumination light is emitted from the light source 1 onto the evaluation mask 300 placed on the mask stage 3 via the illuminating optical system 2. The light transmitted through the evaluation masks 200 and 300 is then projected, via the projecting optical system 4, onto the substrate stage 5 on which the wafer 6 having the photosensitive film 6a formed on its upper face is placed.

The first reference integral exposure amount Eth1 of illumination light emitted from the light source 1 is measured when the first evaluation pattern 103a placed on the outside of the first effective exposure region 101 is developed on the photosensitive film 6a in the first evaluation region X1 (or when the film thickness of the residual amount of the resist film becomes zero). The second reference integral exposure amount Eth2 of illumination light emitted from the light source 1 is also measured when the second evaluation pattern 103b placed on the outside of the second effective exposure region 102 is developed on the photosensitive film 6a in the second evaluation region X2 (or when the film thickness of the residual amount of the resist film becomes zero). Further, the unit reference integral exposure amount Eth0 of illumination light emitted from the light source 1 is measured when the first effective exposure region 101 is developed on the photosensitive film 6a in the first reference region 6a1 (or when the film thickness of the residual amount of the resist film becomes zero) (step S2).

Although the unit reference integral exposure amount Eth0 is measured in the region Y1 of the first reference region 6a1 in this example, it may be measured in some other region of the first reference region 6a1.

A first evaluation value Fip and a second evaluation value Fi are then calculated. First, the illumination light is emitted from the light source 1 onto the first reference region 6a1 of the wafer 6 via the first effective exposure region 101, so that the integral exposure amount to be emitted becomes an appropriate value. The certain period of time during which such exposure is performed will be hereinafter referred to as a “period”. The first integral exposure amount E1 of light reaching the first evaluation region X1 of the wafer 6 can be estimated according to the formula (1) using the unit integral exposure amount E0 of light reaching the first reference region 6a1 of the wafer 6 during the same period. The formula (1) is based on the fact that the integral exposure amount of the exposure light reaching a region on the wafer may be regarded as proportional to the reciprocal of the minimum integral exposure amount of illumination light required to make the residual film thickness of the resist film zero in the region.

E1=(Eth0/Eth1)×E0 (1)

The amount obtained by dividing the unit reference integral exposure amount Eth0 by the first reference integral exposure amount Eth1 in the formula (1) is defined as Fip as in the following formula (2), and is hereinafter referred to as the first evaluation value.

Fip=Eth0/Eth1 (2)

The first evaluation value Fip is ideally as close to zero as possible. However, the first evaluation value Fip is normally not zero, being such a finite value that the first reference integral exposure amount Eth1 does not go beyond the measurement range. If the optical systems of the exposure tool are clouded, on the other hand, part of the exposure light is repeatedly reflected diffusely inside the optical systems, and leaks outside the first reference region 6a1 of the wafer 6, resulting in an increase in the reaching light amount. In other words, the amount of light reaching the first evaluation region X1 of the wafer 6 increases. In this case, the first reference integral exposure amount Eth1 becomes smaller. On the other hand, the first evaluation value Fip becomes greater. Therefore, the first integral exposure amount E1 of light reaching the first evaluation region X1 of the wafer 6 is expected to increase according to the formula (1). For this reason, the first evaluation value Fip can serve as an indicator of the cloudiness of the optical systems in the exposure tool.

Likewise, the second integral exposure amount E2 of the light reaching the second evaluation region X2 of the wafer 6 can be estimated according to the following formula (3) using the unit integral exposure amount EU of the light reaching the first reference region 6a1 of the wafer 6 during the same period. Like the formula (1), the formula (3) is based on the fact that the integral exposure amount of the light reaching a region on the wafer may be regarded as proportional to the reciprocal of the minimum integral exposure amount of illumination light required to make the residual film thickness of the resist film zero in the region.

E2=(Eth0/Eth2)×E0 (3)

The amount obtained by dividing the unit reference integral exposure amount Eth0 by the second reference integral exposure amount Eth2 in the formula (3) is defined as Fi as in the following formula (4), and is hereinafter referred to as the second evaluation value.

Fi=Eth0/Eth2 (4)

Like the first evaluation value Fip, the second evaluation value Fi can serve as an indicator of the cloudiness of the optical systems of the exposure tool, but is more sensitive to the cloudiness of the illuminating optical system than the first evaluation value Fip is. This is because the light transmission amount of the second effective exposure region 102 is designed to be smaller than the light transmission amount of the first effective exposure region 101. In other words, when the second effective exposure region 102 is used, the amount of exposure light transmitted from the illuminating optical system to the projecting optical system is smaller than when the first effective exposure region 101 is used. Accordingly, the contribution of the diffuse reflection in the projecting optical system to the increase in the amount of light leaking out of the first reference region 6a1 of the wafer 6 can be restricted. In general, the second reference integral exposure amount Eth2 is larger than the first reference integral exposure amount Eth1, and the second evaluation value Fi is smaller than the first evaluation value Fip.

In an ideal embodiment, the light transmission amount of the second evaluation region X2 is set at zero, so that the second evaluation value Fi can serve as an indicator of the cloudiness of the illuminating optical system. Particularly, when the illuminating optical system in the exposure tool is clouded, the second integral exposure amount E2 of the light reaching the first evaluation region X1 is expected to increase, according to the formula (4). The second evaluation value Fi in practice is useful to control the cloudiness of the illuminating optical system, serving as an indicator more sensitive to the cloudiness of the illuminating optical system than the first evaluation value Fip is.

As described above, the first and second evaluation values Fip and Fi serve as effective indicators to evaluate the amounts of light leaking out of the effective exposure regions.

In this manner, the first evaluation value Fip is obtained by dividing the unit reference integral exposure amount Eth0 by the first reference integral exposure amount Eth1, and the second evaluation value Fi is obtained by dividing the unit reference integral exposure amount Eth0 by the second reference integral exposure amount Eth2 (step S3).

To control the flare, a first control limit value is set for the first evaluation value Fip, and a second control limit value is set for the second evaluation value Fi, for example. The first control limit value may be the first evaluation value Fip obtained when the total cloudiness of the illuminating optical system 2 and the projecting optical system 4 reaches the control limit (for example, when the exposure margin is equal to or less than a predetermined value). The second control limit value may be the second evaluation value Fi obtained when the cloudiness of the illuminating optical system 2 reaches the control limit (for example, when the exposure margin is equal to or less than a predetermined value).

In view of this, when the first evaluation value Fip is determined to be greater than the first control limit value as a result of a comparison between the first evaluation value Fip and the first control limit value, the total flare amount of the illuminating optical system 2 and the projecting optical system 4 is determined to be greater than a first specified value. When the second evaluation value Fi is determined to be greater than the second control limit value as a result of a comparison between the second evaluation value Fi and the second control limit value, the flare amount of the illuminating optical system 2 is determined to be greater than a second specified value. When the first evaluation value Fip is greater than the first control limit value and the second evaluation value Fi is not greater than the second control limit value, the flare amount of the projecting optical system 4 is determined to be greater than the second specified value (step S4).

When the first evaluation value Fip is not greater than the first control limit value and the second evaluation value Fi is not greater than the second control limit value, the cloudiness of each optical system is determined to be within the control limit, and the operation flow comes to an end.

When the first evaluation value Fip is determined to be greater than the first control limit value at step S4, the total cloudiness of the projecting optical system 4 and the illuminating optical system 2 as the subject optical systems is determined to exceed the control limit. In this case, maintenance is performed on at least one of the projecting optical system 4 and the illuminating optical system 2, so as to remove the cloudiness (step S5). In this manner, the first evaluation value Fip is returned to a value that is not greater than the first control limit value.

When the second evaluation value Fi is greater than the second control limit value, the cloudiness of the illuminating optical system 2 as the subject optical system is determined to exceed the control limit. In this case, maintenance is performed to remove the cloudiness of the illuminating optical system 2. In this manner, the second evaluation value Fi is returned to a value that is not greater than the second control limit value.

When the first evaluation value Fip is greater than the first control limit value and the second evaluation value Fi is not greater than the second control limit value, the cause of the cloudiness exceeding the control limit is not the cloudiness of the illuminating optical system 2, and therefore, maintenance is performed on the projecting optical system 4.

After the maintenance is performed at step S5, the operation returns to step S1, and the light transmitted through the evaluation mask 100 is projected onto the wafer 6 placed on the substrate stage 5, as described above. After step S1, the procedures of steps S2 and S3 are carried out, and the first evaluation value Fip and the second evaluation value Fi are again calculated.

If the first evaluation value Fip again calculated is determined to be greater than the first control limit value as a result of a comparison between the first evaluation value Fip and the first control limit value at step S4, the total flare amount of the illuminating optical system 2 and the projecting optical system 4 is determined to be greater than the first specified value, as described above. If the second evaluation value Fi again calculated is determined to be greater than the second control limit value as a result of a comparison between the second evaluation value Fi and the second control limit value, the flare amount of the illuminating optical system 2 is determined to be greater than the second specified value, as described above.

Thereafter, the operation moves on to step S5, and the same procedure as above is carried out.

If the first evaluation value Fip is not greater than the first control limit value and the second evaluation value Fip is not greater than the second control limit value, the cloudiness of each of the optical systems is determined to be within the control limit, and the operation flow comes to an end.

In the above manner, the cloudiness of each of the optical systems in the exposure tool 1000 is properly controlled.

A sensor device (not shown) that measures the exposure amount may be placed on the substrate stage 5, so that the first integral exposure amount E1, the second integral exposure amount E2, and the unit integral exposure amount E0 are directly measured by the sensor device at a height close to the height at which the upper face of the wafer 6 is located (the substrate surface position). In such a case, the first evaluation value Fip and the second evaluation value Fi are calculated according to the formulas (2) and (4), based on the first integral exposure amount E1, the second integral exposure amount E2, and the unit integral exposure amount E0 measured at the height close to the height at which the upper face of the wafer 6 is located (the substrate surface position). The following is a description of the operation to be performed in such a case.

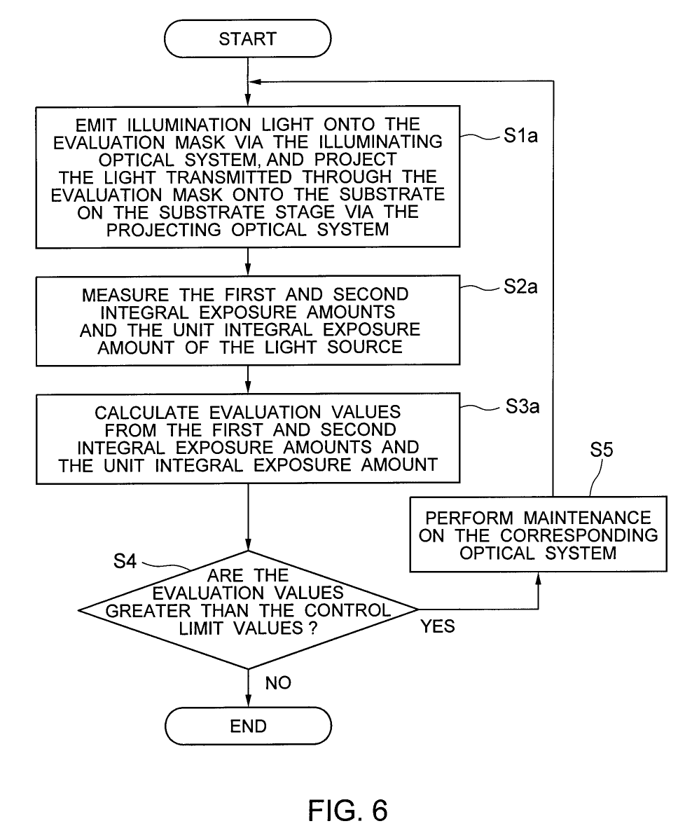

FIG. 6 is a flowchart showing another example of the method for evaluating the flare in the exposure tool according to the first embodiment of the present invention. In FIG. 6, the procedures of steps S4 and S5 are the same as those in FIG. 5.

As shown in FIG. 6, with the use of the exposure tool 1000 having the mask 100 shown in FIG. 2, the illumination light is emitted from the light source 1 onto the evaluation mask 100 placed on the mask stage 3 via the illuminating optical system 2. In this manner, the light transmitted through the evaluation mask 100 is projected onto the substrate stage 5 onto which the wafer 6 is provided via the projecting optical system 4 (step S1a).

The sensor device then measures the first integral exposure amount E1 at a first substrate surface position on the substrate stage 5 having the first evaluation pattern 103a projected thereon, a second integral exposure amount E2 at a second substrate surface position on the substrate stage 5 having the second evaluation pattern 103b projected thereon, and the unit integral exposure amount E0 at a reference substrate surface position on the substrate stage 5 having the first effective exposure region 101 projected thereon, for the same period of time (during the same period) (step S2a).

When the first integral exposure amount E1, the second integral exposure amount E2, and the unit integral exposure amount E0 are measured for different periods of time, the amount of illumination light to be emitted from the light source 1 needs to be fixed.

As shown in the following formula (5), the first evaluation value Fip is then calculated by dividing the first integral exposure amount E1 by the unit integral exposure amount E0.

Fip=E1/E0 (5)

As shown in the following formula (6), the second evaluation value Fi is also calculated by dividing the second integral exposure amount E2 by the unit integral exposure amount E0.

Fi=E2/E0 (6)

The procedures to be carried out thereafter are the same as those of the flowchart shown in FIG. 5, as described above. By the method illustrated in FIG. 6, the cloudiness of each of the optical systems in the exposure tool 1000 can also be properly controlled.

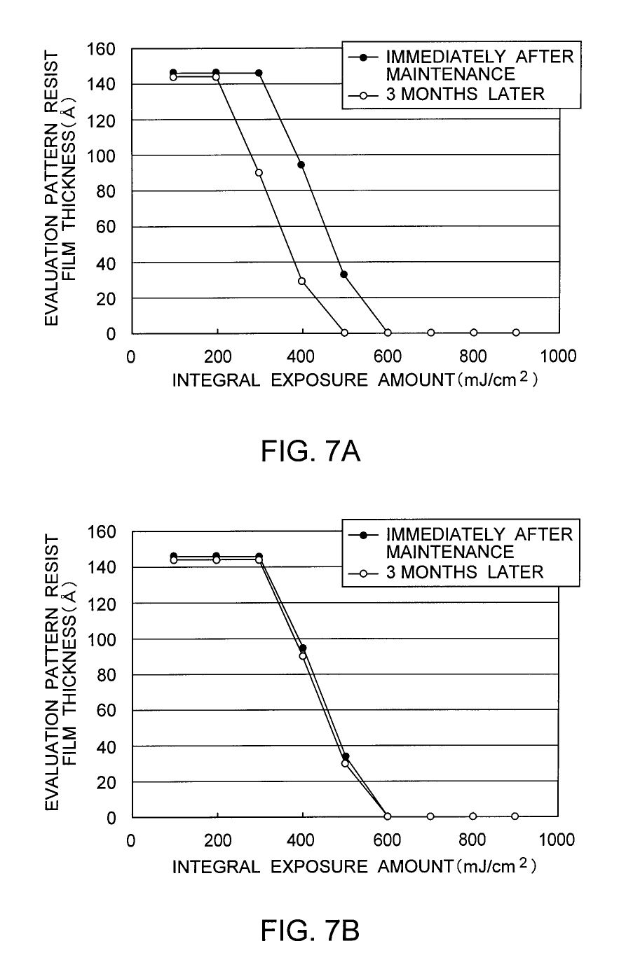

FIG. 7A shows the relationship between the resist film thickness in the first evaluation region X1 having the first evaluation pattern 103a of the evaluation mask 100 projected thereto, and the integral exposure amount of illumination light emitted from the light source 1. FIG. 7B shows the relationship between the resist film thickness in the second evaluation region X2 having the second evaluation pattern 103b of the evaluation mask 100 projected thereto, and the integral exposure amount of illumination light emitted from the light source 1. In FIGS. 7A and 7B, data is plotted with respect to a case where the resist is exposed to light after maintenance is performed on the optical systems, and a case where the resist is exposed three months later.

As shown in FIG. 7A, changes with time are observed in the film thickness of the resist film at the position onto which the first evaluation pattern 103a adjacent to the first effective exposure region 101 is projected.

On the other hand, as shown in FIG. 7B, no changes with time are observed in the film thickness of the resist film at the position onto which the second evaluation pattern 103b adjacent to the second effective exposure region 102 is projected.

As can be seen from FIGS. 7A and 7B, the illuminating optical system 2 of the exposure tool 1000 is not clouded, but the projecting optical system 4 is clouded. Accordingly, maintenance can be appropriately performed on the necessary part (the projecting optical system 4).

As described above, by the method for evaluating the flare in the exposure tool according to this embodiment, the flare of the optical systems of the exposure tool can be more efficiently controlled.

Particularly, the origin of the flare leaking out of the effective exposure region can be determined whether to be the illuminating optical system or the projecting optical system, so that maintenance can be efficiently performed only on the necessary part.

### Second Embodiment

The evaluation mask described in the first embodiment is a mask that penetrates illumination light and is used in ArF exposure tools, KrF exposure tools, i-ray exposure tools, and the likes.

However, the evaluation mask may also be used in Extreme Ultra-Violet (EUV) exposure tools that reflect illumination light.

A second embodiment of the present invention concerns a structure that uses an evaluation mask that reflects illumination light.

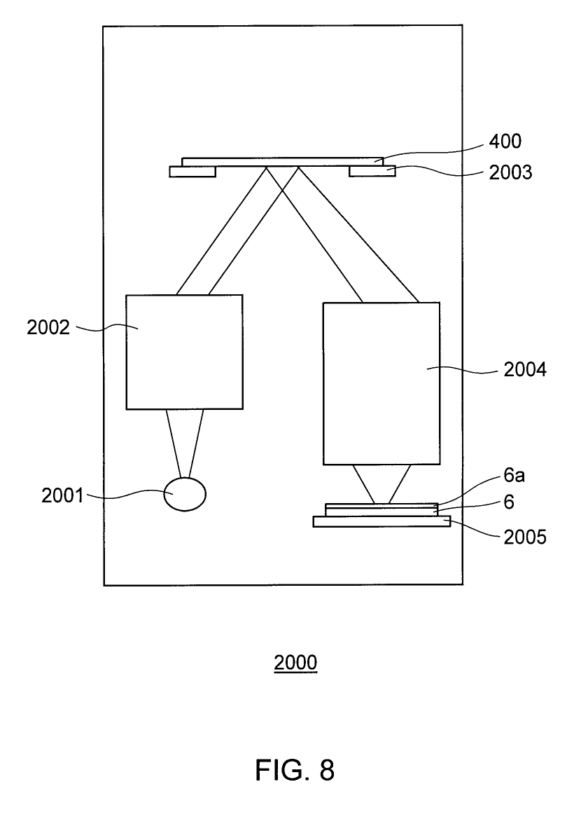

FIG. 8 is a schematic view showing the fundamental structure of an exposure tool 2000 according to the second embodiment of the present invention.

As shown in FIG. 8, the exposure tool 2000 includes a light source 2001, an illuminating optical system 2002, a mask (reticle) 400, a mask stage 2003, a projecting optical system 2004, and a substrate stage 2005.

The light from the light source 2001 is gathered by the illuminating optical system 2002 formed with an ellipsoidal reflector and a collimator lens, for example, and is emitted as illumination light onto the evaluation mask 400. The illumination light is adjusted by slits 2a formed in the illuminating optical system 2002, so as to be emitted onto an exposure region (an effective exposure region) including one unit circuit pattern formed on the evaluation mask 100. Evaluation patterns are formed on the evaluation mask 400, as on the evaluation mask of the first embodiment.

The reflected light that is generated by emitting the illumination light onto the evaluation mask 400 (or the light reflected by the evaluation mask 400) is projected onto and exposes a photosensitive film 6a applied onto a wafer (substrate) 6 placed on the substrate stage 2005 via the projecting optical system 2004.

Like the evaluation mask 100 shown in FIG. 2, the evaluation mask 400 has a first effective exposure region 101 and a second effective exposure region 102 neighboring the first effective exposure region 101 in the effective exposure region onto which the illumination light is emitted to develop a predetermined pattern on the photosensitive film 6a.

The first effective exposure region 101 transmits (or reflects, in this example) the illumination light emitted from the illuminating optical system 2002 to the projecting optical system 2004 by a first transmission amount.

The second effective exposure region 102 transmits the illumination light to the projecting optical system 2004 by a second transmission amount that is smaller than the first transmission amount.

The reflectivity of the first effective exposure region 101, which is equivalent to the first transmission amount, is set higher than the reflectivity of the second effective exposure region 102, which is equivalent to the second transmission amount. For example, the reflectivity of the second effective exposure region 102 is set at approximately 0%. In this manner, two levels are set for the reflectivity with respect to the illumination light reaching the projecting optical system 2004.

As in the first embodiment, a peripheral region 105 is formed outside the first and second effective exposure regions 101 and 102 on the evaluation mask 400. The peripheral region 105 has lower reflectivity than the first effective exposure region 101.

In the peripheral region 105, a first evaluation pattern 103a is formed at a position adjacent to the first effective exposure region 101. The first evaluation pattern 103a transmits (reflects) the illumination light to the projecting optical system 2004.

In the peripheral region 105, a second evaluation pattern 103b is formed at a position adjacent to the second effective exposure region 102. The second evaluation pattern 103b transmits (reflects) the illumination light to the projecting optical system 2004.

More specifically, in the peripheral region 105 on the evaluation mask 400, the first and second evaluation patterns 103a and 103b are formed on the inner side of a pattern formed outside a regular effective exposure region such as a reticle alignment pattern. The first and second evaluation patterns 103a and 103b have the same reflectivity as that of the first effective exposure region 101.

Accordingly, the first and second evaluation patterns 103a and 103b serve to transmit the illumination light leaking out of the effective exposure region to the projecting optical system 2004, as in the first embodiment.

If the illuminating optical system 2002 is not clouded, the first and second evaluation patterns 103a and 103b are ideally formed in regions not to be subjected to the illumination light emitted from the illuminating optical system 2.

Here, the first and second effective exposure regions 101 and 102, and the first and second evaluation patterns 103a and 103b are formed on the single evaluation mask 400. However, the set of the first effective exposure region 101 and the first evaluation pattern 103a may be formed on an evaluation mask, and the set of the second effective exposure region 102 and the second evaluation pattern 103b may be formed on another evaluation mask, as in the first embodiment (FIG. 3).

As described above, the evaluation mask 400 having two levels set for the reflectivity of the effective exposure regions 101 and 102 may also be used according to the present invention, like the evaluation mask 100 of the first embodiment having two levels set for the transmissivity of the illumination light reaching the projecting optical system.

Also, in the present invention, the evaluation patterns provided outside the respective effective exposure regions should be made of a material that has sufficiently high reflectivity to transmit the illumination light leaking out of the effective exposure regions to the projecting optical system.

As described above, by the method for evaluating the flare in the exposure tool according to this embodiment, the flare of each optical system in the exposure tool can be more efficiently controlled, as in the first embodiment.

What is claimed is:

1. A method for evaluating flare of an exposure tool comprising:
using a first evaluation mask that has a first effective exposure region and a first evaluation pattern formed thereon, the first effective exposure region transmitting a first transmission amount of illumination light emitted from an illuminating optical system to a projecting optical system, the first evaluation pattern being adjacent to an outside of the first effective exposure region;
projecting light transmitted from the first evaluation mask, via the projecting optical system, onto a substrate having a photosensitive film formed on an upper face thereof, by emitting illumination light from a light source onto the first evaluation mask via the illuminating optical system;
measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film;
calculating a first evaluation value by dividing the unit reference integral exposure amount by the first reference integral exposure amount; and
evaluating a total flare amount of the illuminating optical system and the projecting optical system, using the first evaluation value.

2. The method according to claim 1, further comprising
performing maintenance on at least one of the projecting optical system and the illuminating optical system, when the first evaluation value is greater than the first control limit value.

3. The method according to claim 1, wherein the illumination light penetrates the first evaluation mask.

4. The method according to claim 1, wherein the first evaluation mask reflects the illumination light.

5. A method for evaluating flare of an exposure tool comprising:
using a first evaluation mask that has a first effective exposure region, a first evaluation pattern formed thereon, a second effective exposure region, and a second evaluation pattern formed thereon, the first effective exposure region transmitting a first transmission amount of illumination light emitted from an illuminating optical system to a projecting optical system, the first evaluation pattern being adjacent to an outside of the first effective exposure region, the second effective exposure region transmitting a second transmission amount of illumination light to the projecting optical system, the second evaluation pattern being adjacent to an outside of the second effective exposure region, the second transmission amount being smaller than the first transmission amount;
projecting light transmitted from the first evaluation mask, via the projecting optical system, onto a substrate having a photosensitive film formed on an upper face thereof, by emitting illumination light from a light source onto the first evaluation mask via the illuminating optical system;
measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film;
measuring a second reference integral exposure amount of illumination light emitted from the light source, the second reference integral exposure amount being required for the second evaluation pattern to be developed on the photosensitive film;
calculating a first evaluation value by dividing the unit reference integral exposure amount by the first reference integral exposure amount;
calculating a second evaluation value by dividing the unit reference integral exposure amount by the second reference integral exposure amount;
evaluating a total flare amount of the illuminating optical system and the projecting optical system, using the first evaluation value; and
evaluating a flare amount of the illuminating optical system, using the second evaluation value.

6. The method according to claim 5, wherein the second transmission amount is set at approximately 0%.

7. The method according to claim 5, wherein the second effective exposure region does not have a pattern formed therein.

8. The method according to claim 5, further comprising
performing maintenance on at least one of the projecting optical system and the illuminating optical system, when the first evaluation value is greater than the first control limit value.

9. The method according to claim 5, further comprising
performing maintenance on the projecting optical system, when the first evaluation value is greater than the first control limit value, and the second evaluation value is not greater than the second control limit value.

10. The method according to claim 5, wherein the illumination light penetrates the first evaluation mask.

11. The method according to claim 5, wherein the first evaluation mask reflects the illumination light.

12. A method for evaluating flare of an exposure tool comprising:
using a first evaluation mask and a second evaluation mask, the first evaluation mask having a first effective exposure region and a first evaluation pattern formed thereon, the first effective exposure region transmitting a first transmission amount of illumination light emitted from an illuminating optical system to a projecting optical system, the first evaluation pattern being adjacent to an outside of the first effective exposure region, the second evaluation mask having a second effective exposure region and a second evaluation pattern formed thereon, the second effective exposure region transmitting a second transmission amount of illumination light to the projecting optical system, the second evaluation pattern being adjacent to an outside of the second effective exposure region, the second transmission amount being smaller than the first transmission amount;
projecting light transmitted from the first evaluation mask, via the projecting optical system, onto a substrate having a photosensitive film formed on an upper face thereof, by emitting illumination light from a light source onto the first evaluation mask via the illuminating optical system;
projecting light transmitted from the second evaluation mask, via the projecting optical system, onto the substrate having the photosensitive film formed on the upper face thereof, by emitting illumination light from the light source onto the second evaluation mask via the illuminating optical system;
measuring a first reference integral exposure amount of illumination light emitted from the light source, and a unit reference integral exposure amount of illumination light emitted from the light source, the first reference integral exposure amount being required for the first evaluation pattern to be developed on the photosensitive film, the unit reference integral exposure amount being required for the first effective exposure region to be developed on the photosensitive film;
measuring a second reference integral exposure amount of illumination light emitted from the light source, the second reference integral exposure amount being required for the second evaluation pattern to be developed on the photosensitive film;
calculating a first evaluation value by dividing the unit reference integral exposure amount by the first reference integral exposure amount;
calculating a second evaluation value by dividing the unit reference integral exposure amount by the second reference integral exposure amount;
evaluating a total flare amount of the illuminating optical system and the projecting optical system, using the first evaluation value; and
evaluating a flare amount of the illuminating optical system, using the second evaluation value.

13. The method according to claim 12, wherein the second transmission amount is set at approximately 0%.

14. The method according to claim 12, wherein the second effective exposure region does not have a pattern formed therein.

15. The method according to claim 12, further comprising
performing maintenance on at least one of the projecting optical system and the illuminating optical system, when the first evaluation value is greater than the first control limit value.

16. The method according to claim 12, further comprising
performing maintenance on the projecting optical system, when the first evaluation value is greater than the first control limit value, and the second evaluation value is not greater than the second control limit value.

17. The method according to claim 12, wherein the illumination light penetrates the first evaluation mask and the second evaluation mask.

18. The method according to claim 12, wherein the first evaluation mask and the second evaluation mask reflect the illumination light.
